(19) United States
(12) Patent Application Publication
(10) Pub. No.: US 2002/0168453 A1
(43) Pub. Date: Nov. 14, 2002

(54) Kit containing a snack food and dip-condiment

(75) Inventor: Michael Dean McCutchan, Hamilton, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 09/905,540

(22) Filed: Jul. 13, 2001

Related U.S. Application Data
(60) Provisional application No. 60/217,999, filed on Jul. 13, 2000.

(51) Int. Cl. A23B 4/00

(52) U.S. Cl. 426/115

(57) ABSTRACT

The present invention provides a means for maximizing the presentation of a snack food product in the form of pieces or chips and a dip-condiment therefor, while optimizing the use of scarce resources such as shelf space, transportation space and packaging materials. The kit comprises packaging a plurality of snack pieces in a container that are conducive to dipping with a dip-condiment and a tub that contains the dip-condiment attached to the container. The kit of the present invention has a space efficiency greater than about 0.1 g/cm³. More particularly, the plurality of snack pieces are placed in a nested arrangement within the container.

### CROSS REFERENCE TO A RELATED PATENT

This application claims priority to co-pending and commonly-owned, U.S. Provisional Application Serial No. 60/217,999, Case 8169P, titled, “A Snack Piece & Dip Kit”; filed Jul. 13, 2000 in the name of Michael D. McCutchan.

### FIELD OF THE INVENTION

The present invention relates to packages or kits containing both a plurality of snack pieces and a dip-condiment, wherein the kit has an improved space efficiency and snack piece size. More particularly, the present invention relates to kits containing both a plurality of snack chips and a dip-condiment, wherein the kit has an improved shelf-space efficiency, snack piece size, portability and snack pieces oriented in a nested arrangement.

### BACKGROUND

Wholesale and retail store shelf space is a very valuable commodity and is one element in the direct cost of marketing food items. Thus, the efficient utilization of this shelf space is a critical factor in the economics of marketing and retailing food products. One way to maximize the utilization of store shelf space lies in the design of food product packaging. By designing a product's packaging to be more efficient in its use of the shelf space, the more economical or profitable the product can be. Additionally, a space efficient package better utilizes valuable distribution space, i.e., space on trucks, warehouses, etc., and thus is more economical. Economical use of store shelf and distribution space can be measured by the package's space efficiency. The package's “space efficiency”, as used herein, is defined as the ratio of the total net weight (net wt.) of the product contained within the kit, to the total exterior kit or package volume (ext. vol.).

Snack food pieces, such as potato chips (or “crisps”) or tortilla chips, and dip-condiments (hereinafter “dips”), such as chip dips or salsas, have individually been available for years and consumers enjoy them together as a combination food item.

However, the majority of snack chip packages and dip packages are sold separately. This individual retailing of the snack chips separate from the dip creates several problems.

First, the majority of snack piece packaging, i.e., bags already have low space efficiency and package density. Second, due to the packaging of the snack pieces and the dip in separate packages, the space efficiency and bulk density of snack pieces and dip as a food combination is even lower. Third, once purchased, the user must carry, secure and store two separate items when they transport the chips and dip to a remote location for eventual consumption. And, Finally, generally these packages randomly pack the snack chips within the package and thus permit chip breakage, which is less conducive to dipping.

Therefore, this food combination is not optimal as a portable food item. (“Randomly packing”, as used herein, is defined as the packing of products without affirmatively orienting the product into any nested arrangement or packed alignment.)

Even with all the above issues associated with packaging of randomly oriented snack pieces, it is possible for a consumer to obtain from a retail outlet a snack package which may have a proportion of large snack pieces to facilitate dipping. In this event, the subsequent challenge consumers face is transporting this package of snack pieces on their persons, along with a separate package of dip condiment, to a remote location for consumption of the snack pieces with the dip condiment at a future time. Both the snack package and dip package may be placed in a separate container, for example, a lunch bag, lunch box, backpack, attache, purse, glove box of a vehicle, etc., for later consumption. However, this additional handling can cause further breakage of the chips due to collisions with other items, such as the dip tub, with the snack chip package.

Various executions of packages containing snack pieces with dips in a unitary package or kit are known. However, these kits make a tradeoff between the overall package's space efficiency and portability versus the size of the chip contained within the package. For example, it has been observed that to get both chips that are preferred for dipping, i.e., large enough for dipping, and the dip into a single overall package, the package is usually large, space inefficient and less portable. Or, the package is made smaller to make it more space efficient and portable but then the chips are made small and are not optimal for dipping.

One such chip and dip kit comprises a composite canister having a diameter greater than about 101.6 mm, wherein the canister contains small, randomly packed chips. A flanged tub of dip sauce is suspended in the opening of the canister and occupies the space near the top of the canister. This kit combines chips and dip into a single package; however, it has a low space efficiency due to the large sized canister. Furthermore, the package contains small snack chip pieces; and due to the large headspace, it permits the chips to move substantially, which results in further breakage in transportation or handling.

Another commercial chip and dip kit comprises a thermoformed tray with separate wells designed to contain a sealed tub of dip and a separate sealed bag of small, randomly shaped and packed snack chips. Both the chip bag and the dip tub are placed into the separate wells of the tray and the entire assembly is sealed using a film seal to contain the inner packages. This increases the costs of the kit. The average projected area of whole chips found in this kit is approximately about 1590 square millimeters (mm²). Also, the tray has a large exterior volume compared to the net weight of chips and thus this kit has a low space efficiency.

It is an object of the present invention to provide a unitary kit for providing a plurality of snack pieces and a dip-condiment. It is another object of the present invention to provide a unitary kit for providing both a plurality of snack pieces having a projected area of at least about 1500 mm² and a dip-condiment, wherein the kit has a space efficiency of at least about 0.2 g/cm³.

### SUMMARY OF THE INVENTION

The present invention relates to a kit for containing both a plurality of snack pieces and a dip-condiment in a space efficient package system. The kit includes a canister, a plurality of snack pieces contained within the container, wherein at least one of the snack pieces have a projected area greater than about 1300 mm², a tub attached to the container, and a dip condiment held within said tub. This kit has a space efficiency greater than about 0.1 g/cm³.

The present invention also relates to a kit that includes a container, which contains the plurality of snack pieces in a nested arrangement and a tub connected to the container, which contain the dip-condiment.

In a further embodiment of the present invention, the kit comprises a container, a plurality of snack pieces contained with the container and a tub connected to the container. At least one of the snack pieces contained within the container has an edge-to-edge linear dimension greater than at least about 20 mm. Also, the kit has a space efficiency that is greater than about 0.15 g/cm³.

In still a further embodiment of the present invention, the kit comprises a canister having a bottom wall and at least one side wall attached to the bottom wall, and an opening defined by the side wall and disposed at an end opposite the bottom wall. The kit also includes a plurality of snack pieces contained within the canister, a tub attached to the container and a dip-condiment held within the tub. This kit has a has a space efficiency greater than about 0.15 g/cm³ and a chip to dip-condiment net weight ratio less than 2.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is an exploded perspective view of the preferred embodiment of a snack piece and dip kit, including a cut-away view of a snack piece canister containing a nested arrangement of saddle-shaped chips;

FIG. 2 is a perspective view of a snack piece having a single curve;

FIG. 3 is a cross-sectional view of the snack piece shown in FIG. 3;

FIG. 4 is a perspective view of the preferred embodiment of a snack piece having a compound curve;

FIG. 5 is a cross-sectional view of the snack piece shown in FIG. 5;

FIG. 6 is a top planar view of an alternative embodiment of a curved triangular snack piece;

FIG. 7 is a side elevational view of the snack piece shown in FIG. 6;

FIG. 8 is a perspective view of the snack piece shown in FIG. 6;

FIG. 9 is a perspective view of a nested arrangement of a plurality of the snack pieces as shown in FIGS. 7 through 8;

FIG. 10 a perspective view of the kit shown in FIG. 1, including the band wrap (pre-shrunk) found in the preferred embodiment; and

FIG. 11 is a perspective view of an alternative embodiment of the kit, including the band wrap (pre-shrunk) found in the preferred embodiment.

### DETAILED DESCRIPTION OF THE INVENTION

The present invention relates to a package or kit containing both a plurality of snack pieces and a dip-condiment, wherein the kit has an improved space efficiency and snack piece size. More particularly, the present invention relates to a unitary kit containing both a plurality of snack chips and a dip-condiment, wherein the kit has an improved shelf-space efficiency, snack piece size, portability and snack pieces oriented in a nested arrangement.

Table 1, sets forth some of the snack piece and dip kits available and the corresponding space efficiency, ratio of net weight of chips to net weight of dip contained within the package, the package used for the kit, and the average projected area of whole snack pieces found in each of the snack piece and dip kits respectively. This table is only a representative sample and is not, nor intended to be, all inclusive of the art in the snack chip and dip kit technology area.

TABLE 1

| | Space | | | |
|---|---|---|---|---|
| | Efficiency of | | | |
| | Snack Kits | Ratio of | | Avg. Projected |
| | (net. wt./ext. | Net Weight | Primary | Area of |
| | vol.) | of Chips | Chip | Whole |
| | grams/cm³ | to Dip | Packing | Chips mm² |
| Tostitos Chips & | 0.129 | 0.44 | Bag | 1590 |
| Cheese Dip ® | | | | |
| Tostitos Chips & | 0.116 | 0.50 | Bag | 1590 |
| Salsa ® | | | | |
| Snack-A-Dip ® | 0.134 | 1.50 | Canister | 1060 |
| (Salsa) | | | | |
| Doritos Dippas | 0.109 | 0.47 | Bag | 3700 |
| Chips & Salsa ® | | | | |
| Yan Yan Snacks | 0.228 | 2.00 | Canister | 1190 |
| Meiji ® | | | | |
| Oscar Mayer | 0.308 | 0.66 | Tray | 650 |
| Lunchables | | | | |
| Cheesy Chip | | | | |
| Nachos ® | | | | |

The projected area listed in Table 1 for these kits was an average calculated projected area and was calculated by randomly selecting three whole chips from the kits, measuring each chip's projected area and then calculating the average of these projected areas. Projected area, as used herein, is essentially the area within the two-dimensional outline of the shape of the snack piece. This two-dimensional cross sectional “footprint” of the snack piece forms a projected area that can be determined either by area calculations of a known geometry, a curve integrator, superimposing the actual drawn area on grid paper with predetermined area markings, or by comparing the weight of a piece of paper cut to the footprint outline to a weight of similar paper with a known area. To measure the projected area of the individual snack piece, the snack piece to be measured is placed in an orientation that will yield the largest possible projected area.

The space efficiency of the kits is expressed as density, i.e., in net weight of product per external volume of the package. The external volume of the packages can be measured by simple displacement of water or other fluid or particulate substance such as sand or beads with fluid properties. The volume of the package is equal to the amount of fluid displaced by immersion of the package into the fluid substance. Packages having simple geometries such as rectangles can be measured directly using known geometric formulas for volume as a function of dimensions. The weight of the product contained within the kit can be determined directly by scale or balance. The higher the space efficiency number of the kit, the more efficient the kit is in utilizing the linear space such as store shelf space, i.e., the more product contained within a linear unit of shelf space.

In general, dips are denser than chips. This is due to the dip's space efficient liquid state and its high water and/or lipid composition as compared to the chips' solid state and dry composition. Since the ratio of the amount of chips to dip included in a package may vary, the above space efficiency measure alone may not be satisfactory to characterize the efficiency of a package. For example, a kit with an inordinate excess of dip relative to chips may seem to be more space efficient because it will have a larger net weight of product per unit of volume. However, the utility of this kit as a portable snack chip and dip package is lost because the kit does not have balanced portions chips to dip, i.e., sufficient dip to be used on all chips in the kit or sufficient chips to use with all the dip. Having unbalanced portions of chips and dip within the kit is not optimal for the user.

As Table 1 illustrates, all but one of the kits have chips with an average projected area of approximately 1590 mm² or less. The one package that has chips larger than 1590 mm² has a space efficiency of 0.109. Furthermore, four out of the six kits have space efficiencies of approximately 0.14 grams per cubic centimeter (g/cm³) or less. The two kits that have a space efficiency of greater than approximately 0.14 g/cm³ contains chips having a average projected area of no greater than approximately 1200 mm². No kit in this table has both a space efficiency of at least about 0.15 g/cm³ and a snack piece average projected area of at least about 1300 mm². As illustrated by this table, the snack chip and dip kits available generally make a tradeoff between the package's space efficiency and portability versus the snack piece's size. In other words, the kits are either space inefficient but have large chips conducive for dipping, or space efficient but have small chips non-conducive for dipping.

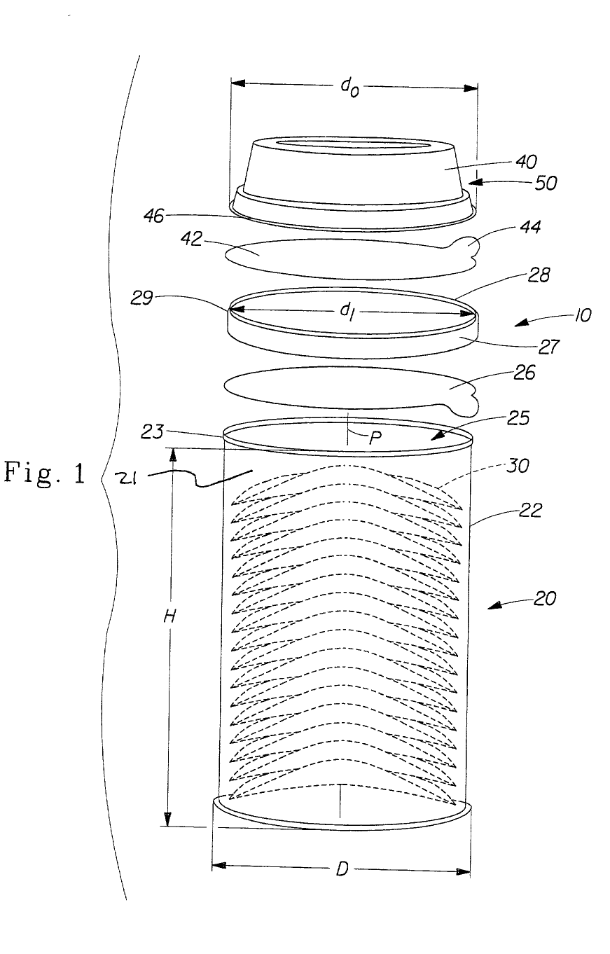

Referring to FIG. 1, a preferred embodiment of kit 10 is shown. The present development has combined a dip-condiment 50 with a plurality of snack pieces 30 sized such that they are conducive to dipping within a space efficient packaging system to form kit 10. There are a variety of ways to embody the present invention to obtain the kit space efficiency and chips that are sized for dipping. In the preferred embodiment, kit 10 includes a container 20, a plurality of snack pieces 30, preferably in a nested or stacked arrangement, contained within container 20, a tub 40 releasably attached to container 20 and a dip-condiment 50 contained within tub 40.

When attached or connected, container 20 and tub 40 are preferably one integral packaging system or “kit” 10, which is desirable during shipping, storing and transporting by the user. When desired, the user can separate tub 40 from container 20 to enjoy the snack piece and dip combination contained within this preferred embodiment. Alternatively, both container 20 and tub 40 can be combined and manufactured as one integral package. For example, container 20 can include both a cavity 21 to hold the plurality of snack pieces and containment area or tub 40 integral to container 20 that can hold dip-condiment 50. Such a unitary package can be manufactured, for example, using a thermoform, blow molding or injection molding process. With this type kit, the user can enjoy the chips with the dip-condiment without having to separate them, which is convenient because the user only has to use one hand to hold the kit while the other hand is free to perform other tasks such as eating the snack pieces and dip-condiment.

Container 20 can be any size or shape but is preferably designed to maximize the kit's space efficiency and one that will allow the snack piece to fit within cavity 21. One preferable way to accomplish this space efficiency is to make kit 10 such that its height H is greater than its longest base linear dimension, such as its diameter D or width W. As shown in FIG. 1, container 20 takes the form of a cylindrical canister. Canister, as used herein, is defined as a container having any cross sectional shape and a height that is greater than its longest base linear dimension, such as its diameter or width W. Although, in the preferred embodiment shown, the canister has a circular cross section, it is intended that the canister can have a variety of cross sectional shapes. Canister does not include trays, i.e., wherein the package's base width is greater than its height.

As shown in FIG. 1, container 20 comprises a continuous side wall 22 and a bottom wall 24 sealably attached to an end of side wall 22. Container 20 also includes an opening 25 defined by side wall 22 and disposed at an opposite end from bottom wall 24. Side wall 22 and bottom wall 24 form cavity 21 wherein the plurality of snack pieces 30 can be held. Also, side wall 22 is preferably sufficiently rigid to protect the snack pieces from breakage under normal storage, shipping and handling conditions. Further, container 22 can include a lip 23 formed by curling the edge of side wall 22 at opening 25. Lip 23 is disposed around the periphery of opening 25. A removable lid 26 may be placed over opening 25 and is preferably sealed to lip 23.

In the preferred embodiment, side wall 22 is comprised of a foil/fiber composite and bottom wall 24 is comprised of metal. The foil fiber canisters used in the preferred embodiment are well known in the art and are manufactured by the Sonoco Corporation. For example, the preferred canister 20 comprises a multilayer laminate consisting of, from inside to outside, an inside layer preferably made of Surlyn® manufactured by the Dupont Co., Inc., a metallized or foil liner, the next two layers are paperboard that are each about 0.010 to about 0.015 inches thick and a printed paper or foil label. Alternately, a label printed on a plastic sleeve could also be used. Alternately, canister 20 can be made from a single or multiple layer of paper or paper board, but this would provide reduced product shelf life since it would be more permeable to oxygen and moisture transmission. A further refinement would be to coat the paper board with a plastic or oil resin to reduce its permeability. Bottom wall 24 can be made of other materials, such as foil fiber laminate, without varying the scope of this invention.

The container's volume, i.e., cavity 21, can vary greatly but is preferably in the range from about 5 fluid ounces (0.15 liters) to about 100 fluid ounces (3 liters), more preferably about 5 fluid ounces (0.15 liters) to about 50 fluid ounces (1.5 liters). The container's dimensions may also vary greatly depending upon the desired package size/portion and the shape of the snack pieces. In the preferred embodiment, the range of the container's height H can be from about 2 inches (50 mm) to about 11 inches (280 mm) and container's 20 diameter D or width W is from about 2 in. (50 mm) to about 6 in. (150 mm).

Preferably the transmission of oxygen or moisture through either the container side wall 22, bottom wall 24 or end seals (i.e., where bottom wall 24 connects to side wall 22 or removable lid 26 connects to lip 23) is very low. Preferably, container 20 is hermetic so as to preserve the desirable attributes of the snack pieces 30 and extend the shelf life of kit 10. The level of oxygen within the sealed package at the point of purchase is preferably less than about 10%, more preferably less than about 5%, and most preferably less than about 2%. To increase snack piece stability and shelf life, container is preferably flushed with an inert gas or a mixture of inert gases, more preferably mostly N₂, prior to applying a removable lid 26. Shelf life for the snack pieces ranges from a few weeks to well over a year depending on package barrier and storage and distribution conditions.

In an alternate embodiment of container 20, container 20 can comprise either a mono-layer or a multiple layer plastic laminate using standard methods of forming, such as thermoforming, blow molding or injection molding, preferably via thermoforming or extrusion blow molding. Plastic packaging offers shape flexibility, fewer components, increased product protection and the opportunity to be lower in cost. Container 20 may be comprised of multiple layers including structural and moisture barriers layers made from resins such as polyolefins and oxygen barrier layers made from resins such as saponified ethylene-vinyl acetate copolymers (EVOH) and are known in the art.

Removable lid 26 can be made from plastic, metal, or a laminate seal that is preferably applied with heat or by adhesive. Lid 26 will preferably be a peelable foil seal and can be purchased from any peelable lid manufacturer, such as American Packaging, Inc. The preferred lid 26 is made from a laminate of the following materials, starting with the innermost layer: Surlyn ® manufactured by DuPont, polyethylene terephthalate, aluminum foil, and paper. The paper layer may be printed with a decorative message. Lid 26 is heat sealed to lip 23, which is formed by rolling over body sidewall 22 to expose a horizontal surface of the canister's inner layer, which is also comprised of Surlyn ® in the preferred embodiment, as previously described. Applying heat and pressure to lid 26 welds the Surlyn ® layers of lid 26 and side wall 22 to form a peelable, yet airtight seal.

Lid 26 may also be preferably covered with a removable and reusable overcap 27. Overcap 27 is placed over removable lid 26 and preferably snap-fits into place. Overcap 27 includes a lip 28 that extends axially from a peripheral edge 29 of overcap 27. Lip 28 has an inner diameter (d₁). This overcap 27 can be used to reclose container 20 after container 20 has been opened by removing lid 26 and disposing it. Such overcaps are commonly known in the art. The overcap can be made of a plastic resin preferably polypropylene (PP), polyethylene (PE) or polyethylene terephthalate (PET), most preferably Linear Low Density Polyethylene (LLDPE) via a thermoforming process or injection molding process, preferably injection molding. The preferred overcap can be purchased from Plastic Enterprises, Inc.

Kit 10 includes at least one snack piece or a plurality of snack pieces, which comprise snack pieces 30, including but not limited to potato chips or crisps, corn-based snack pieces, tortilla chips or crisps, etc, within container 20. One feature of kit 10 is that kit 10 is space efficient yet it has snack pieces that are conducive to dipping, i.e., have a large projected area. The projected area of the snack directly correlates to the capability to hold the snack comfortably while still providing sufficient area to hold the dip. Thus, the greater the projected surface area, the more surface area available on the snack piece for holding dip on the snack piece and for gripping the snack piece.

Snack pieces that are conducive to dipping generally have a projected area greater than about 1000 mm², preferably greater than about 1300 mm², more preferably greater than about 2000 mm², much more preferably from about 1500 mm² to about 10,000 mm², even more preferably from about 1900 mm² to about 4500 mm², most preferably from about 2000 mm² to about 3000 mm².

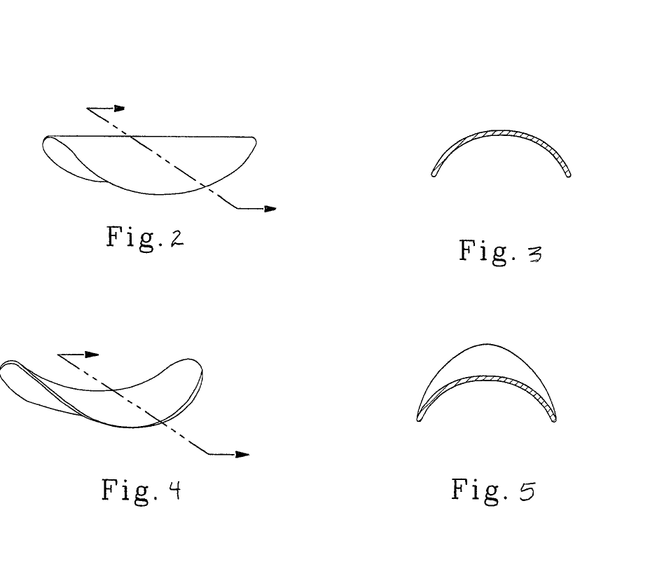

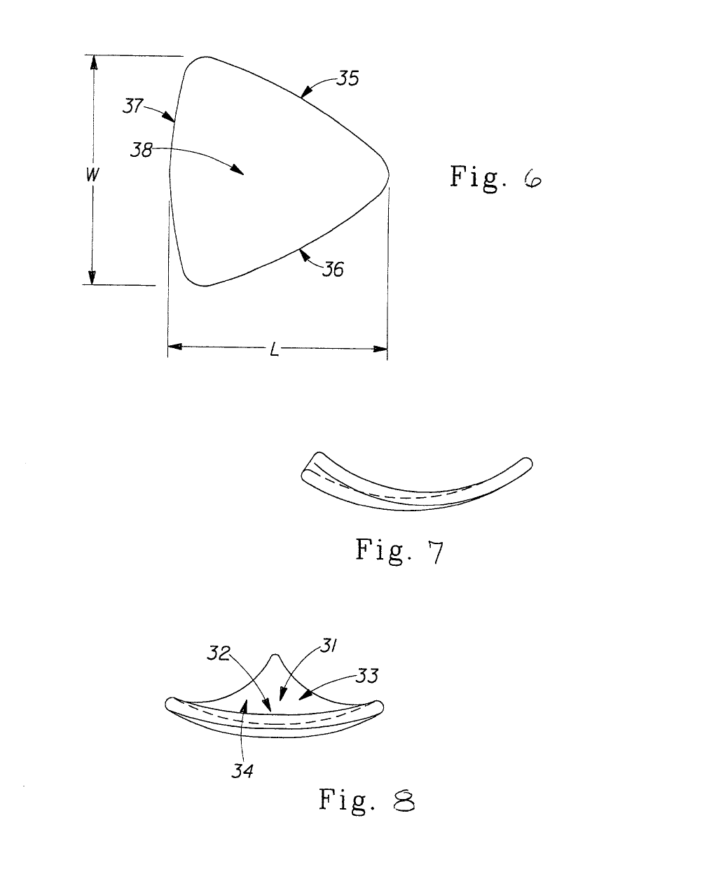

Any shape, size and type of snack piece may be included in the present invention as long as the snack pieces are sized to be conducive for dipping. An individual snack piece comprising snack pieces 30 can be flat, single curved or compound curved. One alternative embodiment of snack piece 30 is a single curved chip or “crisp” as shown in FIGS. 2 and 3. As shown in FIGS. 4 and 5, the most preferred snack piece is oval shaped and compound curved, e.g., “saddle-shape”. The general three-dimensional shape of the snack piece in the preferred embodiment can be described as the shape defined by a surface of a hyperbolic paraboloid onto which a planar ellipse (obtained from an elliptical cut-out of a flat dough sheet prior to frying) has been overlaid. This shape is found in the Pringles ® brand potato crisps marketed by the Procter & Gamble Company, Cincinnati, Ohio. Another alternative embodiment of snack pieces 30 is shown in FIGS. 6, 7 and 8. In this embodiment, snack pieces 30 have a triangular shape and are curved to form a dip containment region 31 and is described in commonly assigned U.S. patent application Ser. No. 09/850,894, P&G Case No. 8073M, titled, “An Ergonomic Snack Piece Having Improved Dip Containment”, filed by Zimmerman et al. on May 8, 2001 and having a priority filing date of May 8, 2000, which is herein incorporated by reference. However, snack pieces 30 can take on other shapes and curvatures without changing the scope of this invention.

To aid in achieving the space efficiency, the snack pieces 30 are preferably uniform in size and shape to allow close packing with minimal space between all points of adjacent snack pieces such as placing the snack pieces in a nested arrangement. The dense nested arrangement allows for a more space efficient package.

The length L of the snack piece at it longest location is preferably greater than about 15 mm, preferably greater than about 30 mm, more preferably greater than about 40 mm and most preferably from about 50 to about 75 mm. The width W of the snack piece at it widest location is preferably greater than about 15 mm, preferably greater than about 30 mm, and most preferably from about 40 to about 65 mm. The aspect ratio, which is defined as the width divided by the length, is preferably greater than about 0.50, more preferably greater than about 0.60, much more preferably greater than about 0.70, and most preferably greater than about 0.75.

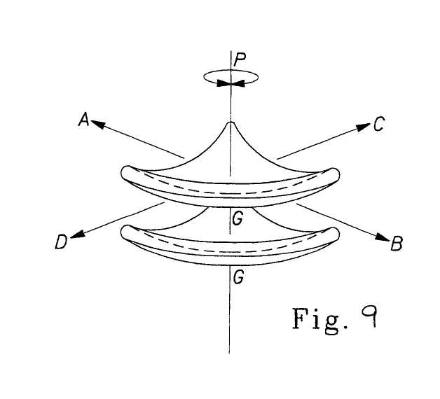

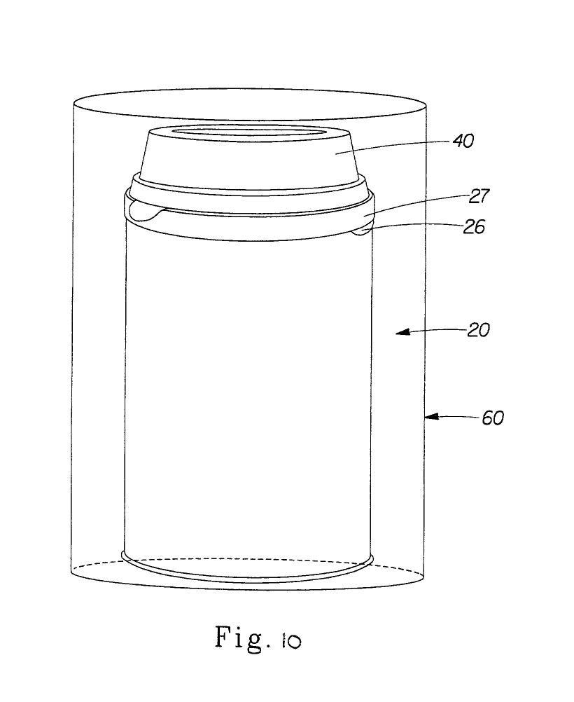

Referring to FIGS. 1 and 9, snack pieces 30 can be arranged in a vertical or horizontal stack or nested arrangement to further increase the space efficiency of kit 10. This stack preferably has an axis P running perpendicularly through the face of each snack piece, wherein the axis contacts each snack piece at similar geometric locations. The shape of snack pieces 30 can be planar or non-planar and is preferably non-planar.

The term “nested arrangement”, as used herein, is defined as snack pieces aligned along a single one-dimensional nesting axis (N) that runs perpendicularly through the face of each snack piece wherein the snack pieces are all facing the same direction so that the pieces can fit within one another. The nested arrangement of the snack pieces in the preferred embodiment comprises vertically stacking the plurality of snack pieces on top of one another. An optimized design of a curved snack piece to accomplish high packed densities of a plurality of curved snack pieces and a method to accomplish such high packed densities are more fully shown and described in co-pending and commonly-owned, U.S. application Ser. No. 09/851,040, P&G Case No. 8072M, titled, “Snack Piece Having Increased Packed Density”; filed May 8, 2001 in the name of Stephen P. Zimmerman and having a priority filing date of May 8, 2000, which is herein incorporated by reference.

Snack pieces 30 can be manufactured from any known method in the art. The following description of the manufacture of the snack pieces forms no part of the invention and is included for the convenience of the reader. Preferably, the snack pieces are fried by a continuous frying method. The snacks can be constrained during frying in an apparatus as described in U.S. Pat. No. 3,626,466 issued to Liepa (1971), which is herein incorporated by reference. The snack pieces of the current invention can are most preferentially formed into a fixed, constant shape by cooking dough pieces between a pair of constrained molds that hold the dough in its shape until the structure is set. The shape of the constrained molds can be modified to deliver the desired shapes of the present development.

The dough pieces are cut from a sheet of dough. The dough used to make the snack piece can be made from a variety of mixing and sheeting processes including but not limited to batch mixing, continuous forming, extrusion, sheeting and gauging rolls, mill rolls, and embossing systems. Suitable doughs for making controlled shaped snack pieces are known in the art and can be found in patents such as U.S. Pat. No. 5,464,643 issued to Lodge (1995) and U.S. Pat. No. 6,066,353 issued to Villagran et al. (2000), which are herein incorporated by reference.

The dough is shaped using a movable, apertured mold half to shape the cut dough pieces and then held during subsequent frying by a second apertured mold half. The dough can be fried to set the final structure to the desired shape. A reservoir containing a frying medium is used. The shaped, constrained pieces are passed through the frying medium until the chip shape is set and the chips are crisp. The snack pieces can be cooked by frying, by partially frying and then baking, by partially baking then frying, by baking, or by any other suitable method. The snack pieces are preferably fried in a fat composition comprising digestible fat, non-digestible fat, or mixtures thereof at temperatures of from about 275° F. (135° C.) to about 450° F. (232° C.) for a time sufficient to form a product having about 6% or less moisture. The total fat content (digestible plus non-digestible fat) of the finished snack piece should be from about 18% to about 40%, preferably from about 22% to about 34%.

In addition, the density of the individual snack pieces should be from about 1.0×10⁻⁴ grams per milliliter g/ml to about 1.70×10⁻³ g/ml, preferably from about 2.0×10⁻⁴ t g/ml to about 1.2×10⁻³ g/ml, and most preferably from about 2.0×10 ⁻⁴ g/ml to about 3.0×10⁻⁴ g/ml. Additionally, the snack pieces 30 are each typically on the order of about 0.5 mm to about 3.5 mm thick.

Kit 10 includes a tub 40 to hold dip condiment 50. This packaging, in the preferred embodiment, is tub 40 that is a physically separate container from container 20. Tub 40 may be made from any package materials old or new in the art of packaging foods. In the preferred embodiment, tub 40 is thermoformed from a polypropylene copolymer sheet to a weight of 3.3 grams for a nominal 2 oz. fluid (0.059 liters) capacity tub. Such a tub is available from Winpack Corporation, as DP200. Tubs constructed from other polymeric structures such as polyethylene, polyethylene terephthalate, polycarbonate, polyvinyl chloride, or from multilayer sheets constructed from these materials and other functional materials such as adhesives, ethyl vinyl alcohol, Surylin®, Saran ® to modify specific properties of the package such as oxygen or water vapor transmission rates may also be used. Other materials such as metals like aluminum or steel, or glass, may also be used. Referring back to FIG. 1, Tub 40 has a bottom wall 48 and at least one side wall 49 that defines an opening 45 to tub 40. Tub 40 may be enclosed via a lid 42.

Preferably, tub 40 is sealed with a laminated foil peel lid 42 designed to provide an airtight seal while also allowing users to peel lid 42 from tub 40 with reasonable effort and with minimal tearing. In the preferred embodiment, peal lid 42 includes a peal tab 44 to hold onto when pealing lid 42 off of tub 40. Sealing is performed by a heating operation, which bonds the sealant layer of lid 42 to a rim on tub 40. Lid 42 is composed from a laminate of the following materials, beginning with the inner surface designed to seal to the tub: 1.25 Mil Sealant Layer, 0.7 Mil Acis Copolymer, 1.5 Mil Aluminum Foil, Print Primer. The exterior surface of lid 42 may be decorated by printing or by affixing a separate label. This lid is available from Winpack Corporation, as LF1512SP. Many other films made from laminates of plastic polymers and/or foil metals, which are well known in the art, may also be used to seal tub 40.

In the present invention, tub 40 is flushed with nitrogen gas to remove oxygen from the headspace prior to sealing, to extend the shelf life of dip condiment 50. Additional treatments to extend shelf life, such as vacuum packing to minimize the partial pressure of all gases in the headspace, particularly oxygen; or nitrogen sparging of dip condiment 50 to remove entrained oxygen prior to sealing may also be performed. In all the aforementioned treatments, other inert gases such as carbon dioxide may be substituted for oxygen to provide similar functionality.

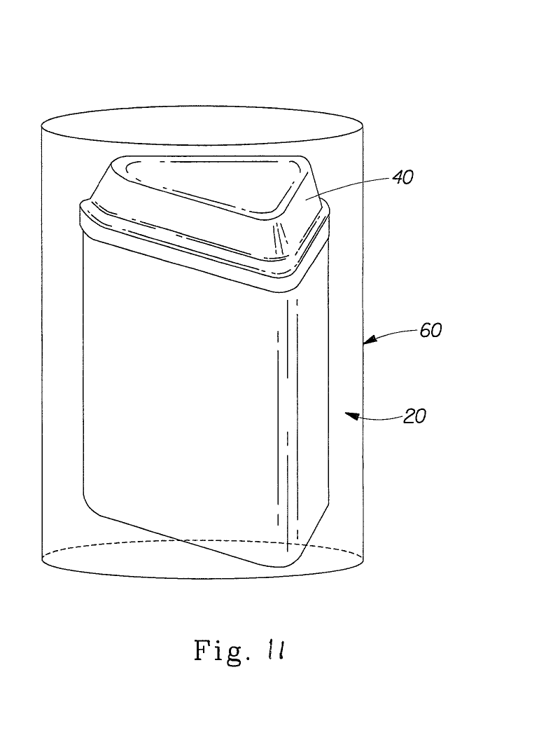

Referring again to FIG. 1 of the preferred embodiment, the outermost edge 44 of tub 40 has a diameter (dₒ) that is less than inner diameter (dᵢ) of lip 28 of overcap 27. This permits tub 40 to rest within lip 28 of overcap 27 and thus prevents tub 40 from becoming juxtaposed relative to container 20. Referring to FIG. 10, a band wrap 60 is applied to the loosely assembled container 20 and tub 40 to firmly join the two pieces to form the preferred embodiment of kit 10. If tub 40 and container 20 are caused to become juxtaposed relative to one another, band wrap 60 could tear or shear at this joint, which is undesirable. Thus, the interlocking feature of tub 40 with overcap 27 in the preferred embodiment is desirable.

In an alternative embodiment, tub 40 could be a tub that inserts into the cavity 21 of container 20 either non-connected to container 20 or connected to container 20. In this embodiment, tub 40 could cover the entire opening 25 or only partially cover opening 25, thus leaving a partial access into cavity 21. In another embodiment, tub 40 could be integrally formed as part of container 20 and within cavity 21 as described previously. In any one of these embodiments, one lid 26 could be used to seal both container 20 and tub 40.

In the preferred embodiment, kit 10 includes a means 60 for releasably connecting container 20 and tub 40. This means 60 for releasably connecting container 20 and tub 40 can be a cylindrical band wrap 60 skirting the assembled chip and dip kit 10 along the circumference of a seam formed by the loosely assembled container 20 and tub 40. Band Wrap 60 is used to hold the assembled kit 10 together. This band 60 can be made from any material, which acts to provide tension and a frictional force in the radial direction to prevent the tub 40 from disengaging from overcap 27 until time-of-use. It further functions to provide additional tension and friction forces in the axial direction to prevent overcap 27 from prematurely disengaging from the container 20. Band 60 can be constructed from band wraps including, but not limited to, a single-sided adhesive tape, an elastic band, or a shrink sleeve. In the present development, a thermally-activated, polymeric shrink sleeve is used to hold the assembled kit 10 together. Such shrinkable sleeves or band wraps 60 are well known in the art. Wrap 60 is made from a uniaxially oriented polymer, preferably polyethylene terepthalate (PET), and is thus designed to shrink preferentially in the radial direction when exposed to an elevated temperature for a brief period of time after positioning on assembled kit 10. In this case, the assembled kit is passed through a tunnel with an atmosphere of saturated steam to affect the shrinkage. This band may be printed on either side to provide for decoration of the assembled unit. The band may be perforated, generally in the axial direction, to form a tear strip to facilitate removal by the consumer at the time of consumption.

In an alternative embodiment, means 60 for releasably connecting container 20 and tub 40 can be integral to overcap 27 of container 20. Lip 28 of Overcap 27 may be designed such that tub 40 snap-fits into lip 27. This can be accomplished by providing lip 28 with a notch on its inner surface such that lip 46 of tub 40 fits snuggly or snap-fits into the notch of lip 28. In still another embodiment, a separate ring may be used that has a bottom portion designed to attach or snap-fit onto the lip 23 of container 20 or overcap 27 and has a top portion designed to attach or snap-fit onto the top of tub 40 such as lip 46.

The nature and composition of the dip condiments 50 which can be packed into dip tub 40 are very typical of dip products known in the art and which are associated with the habit of dipping with snack food chips or pieces including but not limited to salsas, dairy or fat-based dips, i.e., “chip dips”, etc. Flavors include but are not limited to barbecue, hot & spicy, ranch dressing, cheese and seasoned cheese such as jalapeno cheese, honey, mustard, ketchup, sour cream & onion, French onion, salsa, picante, adobo sauce, fruit sauces or jams, bean or refried bean dip, etc. The composition of dip condiment 50 in the present invention is such to maintain microbiological and chemical stability at ambient storage conditions. This is achieved through methods currently known in the art, including control of pH, salt concentration, water activity, and/or the use of chemical preservatives such as the various salts of ethylenediaminetetraacetic acid, sorbic and benzoic acid salts such as sodium benzoate or potasium sorbate. Control of the rheology of the dips is also important to ensure the dip is not too thick or plastic to ensure dipping can be performed without excessive chip breakage, or not so thin or Newtonian in consistency which would cause excessive spillage of the dip from the tub and/or cause too little dip to cling to the chip during dipping. Rheological control is achieved through methods currently well known in the art, such as the control of solid contents of one or more of the ingredients, the addition of a texturizing ingredient such as food gums, or via processing steps such as homogenization to control the size distribution of liquid phases within an emulsion. Specifically, the preferred embodiment of kit 10 includes at least one of the four condiments 50 set forth below. The preferred composition of dip condiment 50 is as follows:

| | |
|---|---|
| Fireblast (hot & spicy flavor dip): | |
| Pepper Sauce (peppers, vinegar, natural | Salt |
| butter flavor, salt, xanthan gum, sodium | |
| benzoate(preservative), postasium | |
| sorbate(preservative)) | |
| Tomato Paste | Distilled Vinegar |
| Water | Modified Food Starch |
| High Fructose Corn Syrup | Sodium Benzoate(preservative) |
| Corn Syrup | Potassium Sorbate(preservative) |
| Tex'n Grill (barbeque sauce) | |
| High Fructose Corn Syrup | Molasses |
| Water | Modified Food Starch |
| Tomato Paste | Spice |
| Vinegar | Garlic Powder |
| Salt | Onion Powder |
| Natural Hickory Smoke Flavor | Sodium Benzoate(preservative) |
| Ravin' Ranch (ranch dressing dip): | |
| Soybean Oil | Monosodium Glutamate |
| Water | Onion Powder |
| Distilled Vinegar | Polysorbate 60 |
| Corn Syrup | Xanthan Gum |
| Egg Yolk | Sodium Benzoate(preservative) |
| Buffermilk Solids | Polysorbate(preservative) |
| Salt | Spice |
| Natural Flavor | Lactic Acid |
| Garlic Powder | Calcium Disodium EDTA (to |
| | protect flavor) |
| ‘Flamin’ Cheese | |
| (jalapeno flavored cheese dip): | |
| Cheddar Cheese(Milk, Cheese Cultures, | Jalapeno Peppers |
| Salt, Enzymes) | Salt |
| Water | Lactic Acid |
| Partially Hydrogenated Soybean Oil | APO Carotenal(color) |
| Sodium Phosphate | Xanthan Gum |
| Whey | Locust Bean Gum |
| Nonfat Milk | Guar Gum |

Kit 10 permits these snack pieces 30 to be combined with a dip condiment 50 into a unitary package assembly that has a space efficiency that is greater than about 0.1 g/cm³, preferably greater than about 0.15 g/cm³, more preferably greater than about 0.2 g/cm³, most preferably from about 0.20 g/cm³ to about 0.40 g/cm³. Kit 10 may be assembled in many different package forms and combinations to accomplish a kit that has both high space efficiency and snack pieces 30 that are conducive to dipping. In addition, kit 10 has a ratio of net weight of snack pieces to net weight of dip-condiment that is less than about 3, preferably less than about 2, more preferably less than about 1.5, most preferably from about 0.4 to about 2.

Further, for the purposes of collating two or more kits 10 for sale as a dual or multi-pack, one can flow wrap two kits 10 inside a plastic bag; mold two kits 10 together; use a tray-like holding device; cardboard carton, wherein the top of a plurality of kits fit into and are held within the multipack or use a cardboard or plastic containment sleeve.

### EXAMPLE 1

In the particular embodiment, canister 20 is about 11.5 fluid ounces (0.340 liters), has a can height H of about 3 and 7/16 inches (87.3 mm) and a diameter D of about 3 inches (76.2 mm).

In the preferred embodiment, kit 10 includes 106 grams of product, i.e., 50 grams of snack pieces 30 in a canister 20 releasably attached to a dip tub 40 containing 56 grams of dip condiment 50. Kit 10 in this example has a space efficiency of 0.25 g/cm³. This optimization allowed for a kit 10 that is, not only shelf stable, but has a high space efficiency and an acceptable shelf presentation.

### EXAMPLE 2

In the particular embodiment, canister 20 is about 11.5 fluid ounces (0.58 liters), has a can height H of about 5 and 19/32 inches (143 mm) and a diameter D of about 3 inches (76.2 mm).

In an alternative embodiment, kit 10 includes 212 grams of product, i.e., 100 grams of snack pieces 30 in a canister 20 releasably attached to a dip tub 40 containing 112 grams of dip condiment 50. Kit 10 in this example has a space efficiency of 0.27 g/cm³. This optimization allowed for a kit 10 that is, not only shelf stable, but has a high space efficiency and an acceptable shelf presentation.

FIG. 11 illustrates an alternative embodiment of kit 10. In this embodiment, kit 10 is triangular shaped. It comprises a container 20, a plurality of triangular shaped snack pieces 30 that are contained within container 20, a triangular shaped tub 40, dip condiment 50 that is contained within tub 40 and a band wrap 60 for releasably connecting tub 40 to container 20.

We claim:

1. A kit for containing both a plurality of snack pieces and a dip-condiment, said kit comprising:
a canister;
a plurality of snack pieces contained within said canister, wherein at least one of said plurality of snack pieces having a projected area greater than about 1300 mm²;
a tub attached to said canister; and
a dip condiment held within said tub;
wherein said kit has a space efficiency greater than about 0.1 g/cm³.

2. A kit according to claim 1, wherein said kit has a space efficiency greater than about 0.15 g/cm³.

3. A kit according to claim 2, wherein said kit further comprising a snack piece to dip net weight ratio less than about 2.

4. A kit according to claim 2, wherein said plurality of snack pieces has a projected area greater than about 1500 mm²

5. A kit according to claim 2, wherein said plurality of snack pieces are in a nested arrangement.

6. A kit according to claim 4, wherein said container has a bottom wall, at least one side wall attached to said bottom wall, an opening defined by said at least one side wall and disposed at an end opposite said bottom wall.

7. A kit for containing both a plurality of snack pieces and a dip-condiment, said kit comprising:
a container;
a plurality of snack pieces contained within said container in a nested arrangement;
a tub connected to said container; and
a dip-condiment contained within said tub.

8. A kit according to claim 7, wherein said container is a canister.

9. A kit according to claim 7, wherein said kit has a space efficiency greater than about 0.15 g/cm³.

10. A kit according to claim 9, wherein said kit has a space efficiency greater than about 0.2 g/cm³.

11. A kit according to claim 10, wherein each of said plurality of snack pieces has a projected area greater than about 1000 mm².

12. A kit for containing both a plurality of snack pieces and a dip-condiment, said kit comprising:
a container;
a plurality of snack pieces contained within said container, wherein at least one edge-to-edge linear dimension of a snack piece of said plurality of snack pieces is greater than at least about 20 mm;
a tub connected to said container; and
a dip-condiment contained within said tub;
wherein said kit has a space efficiency greater than about 0.15 g/cm³.

13. A kit according to claim 12, wherein said kit has a space efficiency greater than about 0.2 g/cm³.

14. A kit according to claim 13, wherein said container has a bottom wall, at least one side wall attached to said bottom wall, an opening defined by said at least one side wall and disposed at an end opposite said bottom wall.

15. A kit according to claim 14, wherein said plurality of snack pieces are in a nested arrangement.

16. A kit according to claim 13, wherein said tub is releasably connected to said container.

17. A kit for containing both a plurality of snack pieces and a dip-condiment, said kit comprising:
a canister having a bottom wall and at least one side wall attached to said bottom wall, an opening defined by said at least one side wall and disposed at an end opposite said bottom wall;
a plurality of snack pieces contained within said canister;
a tub attached to said canister; and
a dip condiment held within said tub;
wherein said kit has a space efficiency greater than about 0.15 g/cm³ and a chip to dip-condiment net weight ratio less than 2.

18. A kit according to claim 17, wherein said kit has a space efficiency greater than about 0.2 g/cm³.

19. A kit according to claim 17, further comprising a removable lid attached to said side wall of said canister and covering said opening.

20. A kit according to claim 19, wherein said kit has a substantially triangular shape.
